(19) United States
(12) Patent Application Publication
(10) Pub. No.: US 2013/0046635 A1
(43) Pub. Date: Feb. 21, 2013

(54) TRIGGERING OFFERS BASED ON DETECTED LOCATION OF A MOBILE POINT OF SALE DEVICE

(71) Applicants: David M. Grigg, Rock Hill, SC (US); Matthew A. Calman, Charlotte, NC (US); Raja Bose, Charlotte, NC (US)

(72) Inventors: David M. Grigg, Rock Hill, SC (US); Matthew A. Calman, Charlotte, NC (US); Raja Bose, Charlotte, NC (US)

(73) Assignee: Bank of America Corporation, Charlotte, NC (US)

(21) Appl. No.: 13/214,004

(22) Filed: Aug. 19, 2011

(51) Int. Cl. G06Q 30/00

(52) U.S. Cl. 705/14.58

(57) ABSTRACT

In general terms, embodiments of the invention relate to methods and apparatuses for triggering the broadcast of offers based on the detected location of a mobile point-of-transaction device. For example, a method is provided that includes: (a) receiving transaction information associated with a financial transaction that occurred on a mobile point-of-transaction (“POT”) device; (b) determining, via a computing system, an entity associated with the mobile POT device; (c) determining a current geographic location of the mobile POT device; (d) determining a geographically targeted audience based at least partly on the current geographic location of the mobile POT device for use in transmitting information associated with the entity; and (e) transmitting information associated with the entity at a time triggered by the computing system.

### BACKGROUND

Mobile businesses and merchants are constantly seeking ways to operate in a sales environment where they are able to deliver sales messages and offers to their target audience at the opportune time. For many, the best time for a consumer to receive their advertisements and offers is when they are physically in the sales area or approaching the sales area. At other times, the most ideal scenario for reaching potential consumers is at a time just before the merchant arrives in a particular geographic region. Additionally, there is a need to provide advertising messages and offers to consumers just-in-time, and at the right place, to allow potential customers to become involved with a mobile merchant's goods and services as they are offered in a constantly changing location.

### SUMMARY OF SELECTED EMBODIMENTS OF THE INVENTION

The following presents a simplified summary of the disclosure in order to provide a basic understanding of some aspects of the invention. This summary is not an extensive or exhaustive overview of the invention. It is not intended to identify key or critical elements of the invention or to delineate the scope of the invention. The following summary merely presents some concepts of the invention in a simplified form as a prelude to the more detailed description provided below.

In general, embodiments of the invention are directed to a computer implemented method for identifying a target audience for receiving information comprising:

(a) receiving transaction information associated with a financial transaction that occurred on a mobile point-of-transaction (“POT”) device, (b) determining, via a computing system, an entity associated with the mobile POT device, (c) determining a current geographic location of the mobile POT device; and (d) determining a geographically targeted audience based at least partly on the current geographic location of the mobile POT device for use in transmitting information associated with the entity.

In yet other embodiments, determining the current geographic location of the mobile POT device comprises determining the current geographic location based, at least in part, on the financial transaction information received from the mobile POT device. In accordance with other embodiments, the current geographic location of a mobile device is determined, wherein determining the current geographic location of the mobile POT device comprises determining the current geographic location based, at least in part, on GPS data received from the mobile POT device.

Transaction information is used, according to some embodiments to determine the current geographic location of a POT device. Receiving transaction information is described in accordance with some embodiments, where receiving transaction information associated with a financial transaction comprises receiving financial transaction information comprising at least an item or service sold, a consumer account, and a holder of the consumer account.

Embodiments are directed to determining a projected future geographic location based on the current geographic location of the mobile POT device, and defining a target area based on the projected geographic location of the mobile POT device, wherein said determining a geographically targeted audience comprises defining the geographically targeted audience based on the target area. Also described herein are methods of determining a current geographic location of a mobile POT device, wherein determining a current geographic location of the mobile POT device comprises: (a) receiving information associated with two or more financial transactions from the mobile POT device, where the information comprises geographic information, and (b) approximating the current geographic location of the mobile POT device based at least in part on the geographic information associated with the information. In such embodiments, determining a current geographic location of the mobile POT device comprises: receiving information associated with a financial transaction from the mobile POT device, where the information comprises consumer account information associated with a consumer participating in the financial transaction, determining a geographic address associated with the consumer account information, and approximating the current geographic location of the mobile POT device based at least in part on the geographic address associated with the consumer account information.

Some embodiments include methods to determine a current geographic location of the mobile POT device comprising: receiving information associated with two or more financial transactions received from the mobile POT device, where the information comprises consumer account information associated with a consumer participating in the respective financial transaction, determining a geographic address associated with the consumer account information for each of the financial transactions, and approximating the current geographic location of the mobile POT device based at least in part on the geographic addresses associated with the consumer account information for the two or more financial transactions. Furthermore, some embodiments project a future geographic location by determining a projected future geographic location based at least in part on the current geographic location of the mobile POT device by determining a geographic address associated with two or more financial transactions received from the mobile POT device, where the geographic addresses indicate a projected path of travel for the mobile POT device. Other methods are given in embodiments of the present invention that work by determining a projected future geographic location based at least in part on the current geographic location of the mobile POT device by determining a geographic address associated with a financial transaction received from the mobile POT device and comparing the geographic address with a pre-planned corridor of travel to thereby determine a future geographic location.

According to some embodiments, a method of defining a target area for transmitting information associated with the entity to users in the target area is given, the method comprising: (1) receiving information associated with first and second financial transactions conducted on the mobile POT device, wherein the information contains at least a time of sale, (2) determining a current geographic location of the mobile POT device where each of the first and second financial transactions occurred, (3) calculating a rate of travel for the mobile POT device in a given timeframe using, at least in part, time of sale information and the current geographic locations of the mobile POT device associated with the first and second financial transactions; and (4) defining a target area based at least in part on the calculated rate of travel.

Some embodiments described herein are directed to methods of transmitting information associated with an entity that is associated with the mobile POT device, wherein transmitting information associated with the entity comprises transmitting information associated with the entity at a time triggered by the computing system.

Yet other embodiments described herein are directed to defining a target area for transmitting information associated with the entity to users in the target area, said defining a target area comprising: (a) receiving information associated with first and second financial transactions conducted on the mobile POT device, (b) determining a current geographic location of the mobile POT device where each of the first and second financial transactions occurred, (c) determining a direction of travel based on the current geographic location determined for the first and second financial transactions, and (d) defining a target area based at least in part on the direction of travel.

Target audiences, in accordance with some embodiments, define a target area. Defining target audiences is given according to some embodiments, wherein defining the target audience further comprises defining a target area based on the current location of the mobile POT device, and wherein said determining a geographically targeted audience comprises defining the geographically targeted audience based on the target area.

Target areas can be defined using a plurality of information. Some embodiments also describe defining a target area based on a time of day, and wherein said determining a geographically targeted audience comprises defining the geographically targeted audience based on the target area. In accordance with embodiments herein, yet other methods of defining a target area are given based on the current calendar date, and wherein said determining a geographically targeted audience comprises defining the geographically targeted audience based on the target area. Using the type of good or service associated with a financial transaction to define a geographically targeted audience is given in some embodiments, where such a method is further comprising defining a target area based on a type of good or service associated with the financial transaction, and wherein said determining a geographically targeted audience comprises defining the geographically targeted audience based on the target area. Yet further, methods are given in some embodiments where a target area is defined based on an input from the entity associated with the mobile point-of-transaction device, and wherein said determining a geographically targeted audience comprises defining the geographically targeted audience based on the target area.

### BRIEF DESCRIPTION OF THE DRAWINGS

Having thus described some embodiments of the invention in general terms, reference will now be made to the accompanying drawings, where:

FIG. 1 is a flow diagram illustrating a general process flow for triggering offers based on the detected location of a mobile point-of-transaction device, in accordance with an embodiment of the present invention;

FIG. 2 is a flow diagram illustrating a more-detailed process flow for triggering offers based on the detected location of a mobile point-of-transaction device, in accordance with an embodiment of the present invention;

FIG. 3 is a block diagram illustrating technical components of a system for triggering offers based on the detected location of a mobile point-of-transaction device, in accordance with an embodiment of the present invention; and

FIG. 4 is a mixed block and flow diagram of a system for triggering offers based on the detected location of a mobile point-of-transaction device in accordance with an embodiment of the present invention.

### DETAILED DESCRIPTION OF EMBODIMENTS OF THE INVENTION

In general terms, embodiments of the invention relate to methods and apparatuses for detecting the current or future location of a point-of-transaction (POT) device by using, at least in part, transaction information available through a financial network pertaining to a transaction on the mobile POT device. For example, some embodiments involve using known consumer information associated with the consumer's account used in the transaction to discover the current location of the POT device.

In some embodiments, the location of the mobile POT device is determined, at least in part, by information associated with the payment accounts of a business consumer or individual consumer that has transacted with the mobile POT. Such a method identifies a time relationship between transactions using a telecommunication network and access to an authorization server, coupled with the brick and mortar address associated with the consumer payment accounts, which may be used, at least in part, to identify the probable location of the mobile POT device.

Some embodiments of the invention describe information being sent to a geographically targeted audience. The recipients of some or all communications, which in some instances are or include offers and/or advertisements, have “opted-in” to receive such messages. Opting-in, in some embodiments, may include explicit input provided by the recipient or potential recipient to receive specific types of messages, while excluding other types of messages, or may include acceptance of any and all types of communications described herein. Such recipient input may be provided by the recipient in response to a prompt from the sender of the information, communications and/or messages. The prompt may be communicated to the recipient in response to the recipient entering a predetermined geographic area. In some embodiments, the recipient may preemptively opt-in using an online banking interface, such as a financial institution and/or merchant website.

In accordance with embodiments of the invention, a geographically targeted audience is determined partly by information pertaining to the time of day the merchant or other entity associated with the POT device is operating in the field of use. For example, if the device is in use during the morning hours, a target area may be defined based on the probable and/or usual locations of consumers that may be eating, drinking beverages, etc. Another example may limit the target area to highly trafficked areas such as entertainment districts during evening hours based on both the time of day and the determined physical location of the mobile POT device. Similarly, embodiments may use information such as the calendar date, where holidays, weekend days (i.e. Saturday and Sunday), etc. are information used by the computing system to determine suitable target areas at the respective time of mobile POT operation in the field.

Some embodiments of this invention discover the approximate physical location of a mobile POT device by (a) receiving information associated with a financial transaction on the mobile POT device, and then (b) calculating the approximate physical locating using the transaction data. More specifically, transaction data can include, in this case, identifying information about an item or service sold, and/or information identifying a specific consumer or account holder. Furthermore, some embodiments may use global positioning system (GPS) coordinates provided by a GPS directly integrated in the mobile POT device, or an external GPS device configured to communicate and share information with the mobile POT.

Some embodiments may discover the location or approximate location of a mobile POT device by (a) retrieving known information that is specific to a consumer payment account by communicating with an authorization server through telecommunications network, and (b) associating the payment account holder to the location or locations of subsequent purchases made with the same payment accounts, forming “transaction events”, then (c) identifying two or more transaction events involving unrelated payment accounts that are transacted on the mobile POT device and (d) approximating the location of the mobile POT device using, at least in part, information associated with the transaction events. Of course a time element may be used to differentiate related transaction events to those buying events which may be coincidental or completely unrelated.

Yet further, some embodiments may approximate the location of a mobile POT device using a method that identifies and compares the physical address associated with a consumer's payment account with the address associated with a payment account of a subsequent consumer or consumers. As an example, if a mobile POT device is used to transact business door-to-door along a contiguous corridor of travel, the payment accounts of consecutive transactions may be compared to discover the approximate location of the POT device given historical transaction data and an element of time between transactions. Transaction “A” is made consecutively with transaction “B,” where the addresses associated with the payment accounts used in the transactions showed that the addresses were contiguous or otherwise geographically related. A determination may be made in such a case that the mobile POT has a high probability of being located in the vicinity of the two contiguous addresses. Of course, some embodiments are dependent on one or more payment accounts used in the transactions being accessible to the mobile POT triggering service, which is the case when the triggering service is provided by the same financial institution as the abovementioned payment accounts.

In some embodiments a method is provided that identifies the probable future corridor of travel of the mobile POT device based, at least in part, on the trajectory and rate of travel of a mobile POT by analyzing known transaction locations. In such embodiments, the rate of travel, direction of travel and probable future corridor of travel is derived, at least in part, on transaction information received from the mobile POT device. In accordance with some embodiments, a geographic region of interest is calculated automatically. The region of interest may be calculated using criteria which may include any one or more, but not limited to: rate of travel, time and distance between transactions, the nature of the goods and services being offered by the merchant, the desired sales area to be covered, and transaction account information. Some embodiments estimate the probable corridor of travel in advance of the mobile POT device reaching the predicted location. Offers related to the goods and services associated with the mobile POT are distributed to consumers located within the geographic region of interest, which may also include regions along the predicted corridor of travel. Still further, in such embodiments, if the mobile POT deviates from the pre-planned corridor of travel, the geographic region of interest for distributing offers to consumers can be adjusted in real time according to the location in which the mobile POT is actually operating. Further still, some embodiments of the present invention will vary the rate at which offers and advertisements are released to respective geographic areas, which may change according to the actual travel rate of the mobile POT. Other embodiments use similar methods for discovering the location of a mobile POT device, yet distribute other types of offers or advertisements to consumers using various telecommunication mediums. As an example, SMS text messaging may be used for delivering messages.

The embodiments described herein may refer to use of a transaction or transaction event to trigger the location of the user and/or the user's mobile device. In various embodiments, occurrence of a transaction also triggers the sending of information such as offers and the like. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smart phone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device (e.g., Nintendo Wii®, PlayStation Portable®, etc.), and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

In accordance with some embodiments, a computer program product is provided that includes a method for a POT operator (i.e. merchant) to pre-plan a corridor of travel based on a known sales or operational business territory. The location of the mobile POT can optionally follow a pre-specified route which has been identified and registered on an online application. The actual location of the mobile POT can thereby be tracked, and offers can be sent to consumers along the pre-planned corridor of travel according to the rate in which the mobile POT is progressing.

In some other embodiments, the computer program product may contain instructions that, when executed, discover the exact location of a mobile POT by receiving data retrieved from a global positing system (GPS) device. In some embodiments, the GPS device may be integrated in the mobile POT device as permanent part of the system. In other embodiments the GPS device may be external and independent to the POT device, yet be operatively connected to the POT device in some wired or wireless fashion or through a network connection. Yet other embodiments may not use a GPS device at all.

Yet other embodiments include the use of an accelerometer for the detection of movement (travel) of a mobile POT device. An accelerometer may determine the direction, rate of travel, and may assist the computing system of the present invention to determine or approximate a location of a POT device. In some embodiments, the accelerometer may be integrated in the mobile POT device as permanent part of the system. In other embodiments the GPS device may be external and independent to the POT device, yet be operatively connected to the POT device in some wired or wireless fashion or through a network connection. Yet other embodiments may not use an accelerometer device at all.

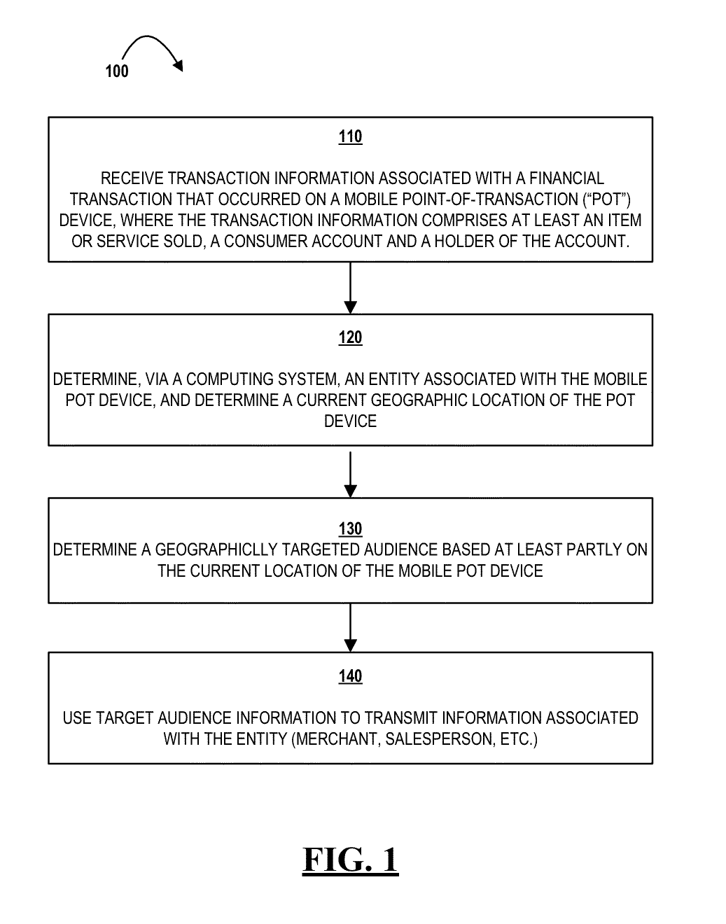

Referring now to FIG. 1, a general process flow 100 for providing a coverage service involving a coverage network is provided, in accordance with an embodiment of the present invention. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive transaction information associated with a transaction, where the transaction involves a buyer account (e.g., a deposit account, a credit account, etc.), an item or items and/or a service or services sold, a holder of the account, and a geographic location at which a transaction takes place. As represented by block 120, the apparatus is also configured to determine, based at least partially on the transaction information, the approximate or exact location of the mobile point-of-transaction (POT) device. In addition, as represented by block 130, the apparatus is further configured to transmit information associated with an entity associated with the POT device, based, at least in partly on the current location of the mobile POT device. As shown in some embodiments, the related information which is transmitted may be an electronic advertisement, or an offer related to the goods or services associated with the mobile POT. As represented by block 140, the apparatus is configured to transmit information directed to a geographically targeted audience, where the audience is determined, at least in part, on transaction information received from the mobile POT device.

For simplicity, it will be understood that the portion of the process flow represented by block 120 is sometimes referred to herein as “discover the location of the device”, or “approximate the location of the device.” Also, any reference to the location of the device may be used synonymously with the “current or future location” of the device. Of course, any exact future location can not be determined, but the term “future location” is referred to herein as the probable approximate location based on known information related to the mobile POT device.

Additionally, it will be understood that, for simplicity, the term “mobile point-of-transaction” is sometimes referred to herein as “POT” or “mobile POT” or “mobile POT device,” or “transaction machine.”

In reference to the term “POT operator,” it will be understood that a “mobile POT operator,” “merchant,” and/or the like are used herein as an entity associated with the mobile POT device. Other terms may include but are not limited to: salesman, salesperson, operator, POT operator, device operator, and/or the like.

In reference to descriptions of a “target area,” or “geographically targeted audience,” or a “geographic region of interest” or “geographic area of interest,” it will be understood that the method of defining the attributes of the geographic area that contains the target audience will vary with each embodiment. For example, if the mobile POT device is used by an ice cream vendor, the target audience may be comprised of a geographic radius of one quarter mile from the location of the POT device. As another example, if the mobile POT device is associated with a door-to-door sales person, then the target audience may be constrained to a radius of 0.2 miles from the approximated location or projected future location of the mobile POT device. As yet another example, the geographically targeted audience may be within a one mile radius along the projected corridor of travel of the merchant using a mobile POT device.

In addition, it will be understood that, the term “determine,” in some embodiments, is meant to have one or more of its ordinary meanings (i.e., its ordinary dictionary definition(s)), but that in other embodiments, that term is meant to have one or more of the ordinary meanings of one or more of the following terms: decide, conclude, verify, ascertain, find, discover, learn, calculate, observe, read, and/or the like. Also, in some embodiments, the phrase “based at least partially on” is meant to have one or more of its ordinary meanings, but in other embodiments, that phrase is meant to have one or more of the ordinary meanings of one or more of the following terms and/or phrases: in response to, after, when, if, as a result of, because of, and/or the like.

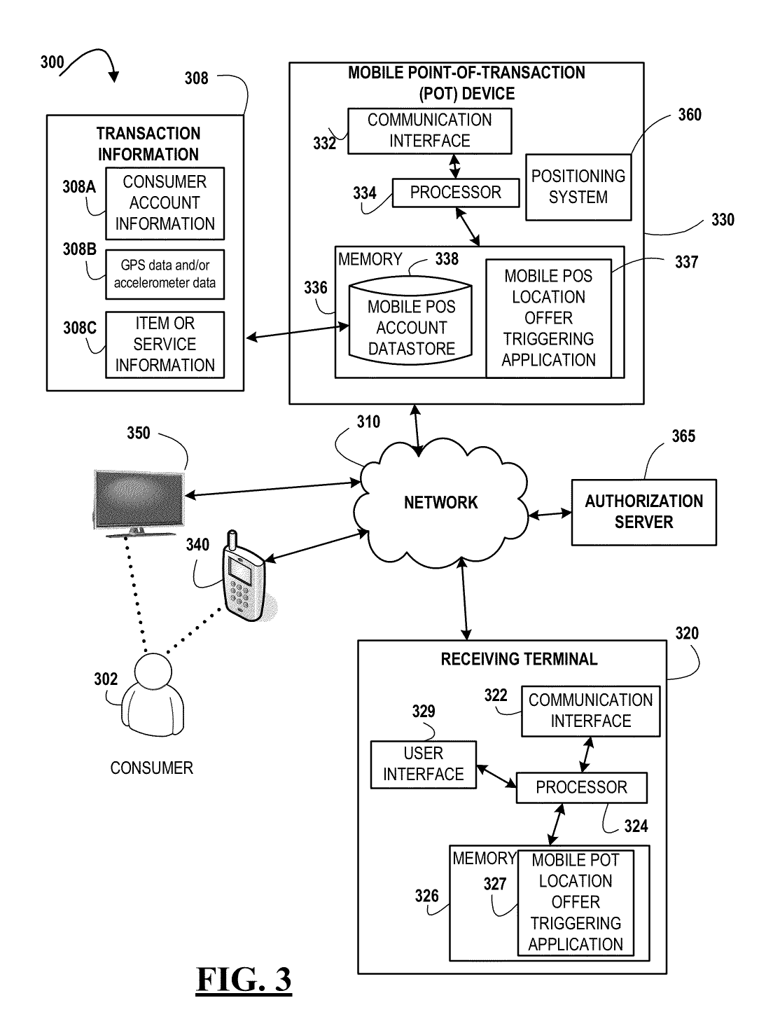

It will also be understood that the apparatus having the process flow 100 can include one or more separate and/or different apparatuses. For example, in some embodiments, one apparatus (e.g., the receiving terminal 320 described in connection with FIG. 3, etc.) is configured to perform the portion of the process flow 100 represented by block 110, and a second apparatus (e.g., the mobile point-of-transaction device 330) is configured to perform portions represented by blocks 110 and 120. As still another example, in some embodiments, a single apparatus (e.g., the authorization server 330) is configured to perform each and every portion of the process flow 100. It will also be understood that, in some embodiments, a receiving terminal (e.g., the receiving terminal 320) is configured to perform one or more (or all) of the portions of the process flow 100, and that in some embodiments, that the mobile POT is the transaction mobile point-of-transaction device (POT) referred to in block 110.

In some embodiments, the consumer account, the mobile POT, and the apparatus having the process flow 100 are each controlled, serviced, owned, managed, operated, and/or maintained (collectively referred to herein as “maintained” for simplicity) by a single financial institution. For example, in some embodiments, the apparatus is maintained by a financial institution, the account is maintained by the financial institution, the transaction machine is owned by the financial institution, and the consumer account holder and mobile POT customer enrolled in the mobile POT location triggering service are customers of the financial institution. Of course, it will be understood that, in some embodiments, the apparatus, the mobile POT device and/or the account are not maintained by the same financial institution (or any financial institution).

Also regarding block 110, the apparatus, and/or system and/or computer program product having the process flow 100 can be configured to receive the transaction information in any way. For example, in some embodiments, the apparatus is configured to receive an authorization request associated with the transaction, where the authorization request includes the transaction information. In some embodiments, the apparatus is embodied as an authorization apparatus maintained by a financial institution, where the apparatus is configured to consider, approve, and/or decline authorization requests for debit transactions, credit transactions, ATM transactions, POT device transactions, and/or one or more other types of transactions that involve one or more accounts maintained by the financial institution.

In some embodiments, the apparatus having the process flow 100 is configured to receive the transaction information based at least partially on the holder presenting account information (e.g., account number, debit card number, credit card number, credentials, PIN, expiration date of debit card or credit card, card verification value (CVV), name(s) of holder(s) of the account, etc.) at the mobile POT. For example, in some embodiments, the holder presents account information at the mobile POT by swiping a debit card or credit card through the POT device. As another example, in some embodiments, the holder presents account information at the POT by inputting account information into the device via a user interface associated with the mobile POT. As still another example, in some embodiments, the holder presents account information at the transaction machine by “tapping” a near field communication (NFC)-enabled mobile device at an NFC-enabled transaction machine (e.g., holding the NFC interface of the mobile device within approximately four inches of the NFC interface of the transaction machine, etc.) in order to communicate the account information from the mobile device to the transaction machine.

Additionally or alternatively, the apparatus having the process flow 100 can be configured to receive the transaction information directly or indirectly from the source of the transaction. For example, in some embodiments, the apparatus is located remotely from the mobile POT but is operatively connected to the mobile POT via a network. As another example, the apparatus may include and/or be included in a mobile POT. For example, in some embodiments, the apparatus having the process flow 100 includes the mobile POT device referred to in block 110. As another example, in some embodiments, the apparatus having the process flow 100 is embodied as the mobile device referred to in block 130. As still another example, in some embodiments, the apparatus having the process flow 100 is embodied as a mobile POT device separate from, and/or different than, the mobile device mentioned in the process flow 100.

Regarding block 120, the term “current geographic location,” as used herein, generally refers to the approximated location of the mobile POT device as it is derived from known information related to the mobile POT or transaction information received from the mobile POT. Examples of information that may be used to determine the future location of a mobile POT device could include any one or more of, but are in no way limited by: the time between recent transactions, known geographic locations of previous transactions, approximations of geographic locations of previous transactions, the corridor of travel that has been recorded or planned in some manner accessible by the apparatus of 100, global positioning system data, transaction information, time of day, calendar day, etc.

Additionally or alternatively, in some embodiments, the apparatus is embodied as a mobile point-of-transaction device (e.g., the mobile POT device 330 referred to in FIG. 3, etc.) that is configured to consider, authorize, and/or decline authorization requests and/or financial transactions. The apparatus configured to perform the process flow 100 can be configured to perform transactions and communicate, via a network, in real time and/or in substantially real time. In some embodiments, the apparatus is configured to determine the location of the mobile POT after a transaction has been initiated (e.g., upon the swipe of a debit or credit card through a POT device, etc.). However, the apparatus having the process flow 100 can be configured to make the location determination at any time during or after the transaction has occurred on the mobile POT device. In other words, the apparatus can be configured to make the mobile POT location determination after the transaction has been initiated (e.g., at a POT device) but before the transaction has been authorized and/or completed. As such, the apparatus can be configured to make the mobile POT location determination while the transaction is a present, initiated, and/or pending transaction, or after a number of transactions have been processed at the mobile device.

Regarding block 140, the phrase “transmitting information,” as used herein, is meant to be used in its broadest sense, but in some embodiments, refers to transmitting electronic advertisements, and/or the transmission of one or more electronic offers related to the goods and/or services associated with the mobile POT. Of course, the type of information transmitted may be in reference to something of a different nature, and unrelated to advertisements and/or offers.

In some embodiments, the transaction information as shown in block 100, which is used to determine location, is associated with the holder (i.e., the consumer FIG. 3 block 302). The transaction information contains a home address specific to the consumer account as shown in block 308A. However, in other embodiments, the transaction information is associated with the goods and/or services transacted 308c (i.e., the transaction information may also disclose what items or service were purchased in the transaction). Transaction information 308 may also include, in some embodiments, location data retrieved from or calculated by a global positioning system (GPS) device as depicted in block 308B, and/or data received from an accelerometer device.

Additionally or alternatively, in some embodiments, the information transmitted in blocks 130-140 are directed to an audience that is targeted geographically based on additional information gathered from consumers using the same social network provided by a social networking service (e.g., Facebook®, MySpace®, Twitter®, LinkedIn®, Google+®, Yelp® etc.). In such embodiments, the apparatus having the process flow 100 can be configured to communicate with a consumer and/or buyer account holder via one or more messages specific to the social network and/or social networking service (e.g., Facebook® messages, Facebook® wall postings, Twitter® direct messages, etc.).

Some embodiments direct offers and/or advertisements to consumers via broadcast telecommunications, (e.g., broadcast television, radio or cable networks, AM/FM radio, text satellite television, etc.), hereafter “telecommunications provider”. In such embodiments, the apparatus having the process flow 100 can be configured to communicate with a telecommunications provider via one or more email messages or other electronic conveyance (i.e. SMS messages, MMS messages, EMS messages, etc.), where the conveyance contains sufficient information to trigger the release of a pre-recorded offer or message. The offer or message sent by the telecommunications provider is directly associated with the goods and/or services provided at the mobile POT. For example, a triggering event (in this example, the output of 110-130) causes the computer system to send an automatic email 140 to a telecommunications provider with whom an agreement is established beforehand, such that a specific offer or message is sent by the telecommunications provider, at a specific time frame for sending the message, and to a specified geographic audience. Of course, the target audience to whom the offer and message to be sent is selectively chosen by the apparatus (i.e. computing system, computer program product, etc.) 130, as is the applicable timeframe for sending the message or offer. In this embodiment, the message or offer sent by the telecommunications provider is sent based on information written and planned automatically (i.e., without human intervention) by the computing system 130-140, based at least partially on the transaction information, the current physical location of the mobile POT device 110 and/or the future location of the mobile POT device 120-130.

Yet other embodiments push (i.e. broadcast, send, deliver, transmit, present, distribute and/or the like) information to consumers using a mobile application provided by the financial institution, whereby the message instructions originate from the mobile application. Mobile applications may be provided, according to some embodiments, as part of a mobile banking platform through which a financial institution may choose to communicate with consumers. The rate in which information is sent to consumers may be controlled, using the apparatus of system flow 100, either automatically without user intervention, or directly controlled, using the apparatus of system flow 100, by the merchant or entity associated with the mobile POT device. For example, in one specific embodiment, if an ice cream vendor is engaged in normal route operations, and the rate of sale is lower than expected (as determined by past sales data or as determined by the mobile POT operator) the rate of offer distribution may be increased automatically by the apparatus associated with system flow 100, and/or the offer may be increased in favor of the consumer (i.e. a higher percentage off of regular price is offered based on the lower transactional activity) automatically by the apparatus associated with system flow 100. Additionally, some embodiments include functionality to allow the merchant associated with the POT device to control the rate and offer details in real time as the sales rate necessitates.

Generally, in some embodiments regarding block 140, transmitting information associated with an entity (such as a merchant) may include sending (i.e. broadcasting, delivering, transmitting, presenting, distributing and/or the like) one or more questions, instructions, messages, graphics, sounds, phone calls, text messages (e.g., SMS messages, MMS messages, EMS messages, etc.), actionable alerts, instant messages, voice messages, voice recordings, interactive voice response (IVR) communications, pages, emails, communications specific to one or more social networking services (e.g., Facebook®, MySpace®, Twitter®, LinkedIn®, Google+®, Yelp® etc.), communications specific to one or more electronic banking services (e.g., online banking, mobile banking, text banking, etc.), and/or the like. For example, in some embodiments, the apparatus having the process flow 100 is configured to send a text message to a mobile phone accessible to a consumer in the geographically targeted audience at a time such that a mobile POT device is in the area. The text message alerts the consumer that the services and/or goods for sale are in the area. As another example, in some embodiments, the apparatus sends an email to a personal computer accessible to a consumer residing or otherwise located in the geographic target area, where the email invites the consumer to take some action associated with the mobile POT. According to some embodiments, a consumer may also forward the transmitted information (i.e. offer or advertisement) to their social network via their chosen aforementioned social networking service(s). For example, information transmitted may be a coupon for half off ice cream sold by a mobile POT device user, whereby the consumer posts the offer to their Facebook® and Google+® networks. The consumer's neighbor, who is also part of the consumer's social network see's the posted Facebook® message and responds by purchasing an ice cream from the merchant.

Still regarding block 140, the apparatus can be configured to prompt the consumer via any device (e.g., personal computer, mobile phone, etc.) maintained and/or accessible to the consumer. In some embodiments, the apparatus prompts the member via a mobile device that is carried by the member at the time of the transaction referred to in block 110. Exemplary mobile devices include mobile phones (e.g., feature phones, smart phones, iPhones®, Droids®, etc.), mobile gaming devices (e.g., PlayStation Portable®, etc.), mobile computers (e.g., tablet computers, laptop computers, etc.), personal digital assistants (PDAs), and/or the like. In some embodiments, the mobile device carried by the consumer is configured to send and/or receive communications (e.g., phone calls, text messages, actionable alerts, emails, social network-specific messages, etc.), present information via a user interface, play video games, and/or the like. In some embodiments, the mobile device is portable (e.g., not stationary) and/or can be carried and/or worn by and/or on a person (e.g., the consumer).

Also, the apparatus having the process flow 100 can be configured to perform any of the portions of the process flow 100 represented by blocks 110-140 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the apparatus is configured such that the apparatus making the current and future mobile POT location estimation (the triggering event) automatically and immediately or nearly immediately (e.g., within 3-30 seconds, etc.) triggers the apparatus to transmit information associated with the merchant, such as the distribution of an offer or advertisement (the triggered action(s)). In some embodiments, the apparatus is additionally or alternatively configured to transmit information associated with the merchant (triggered action) automatically and immediately or nearly immediately after receiving the determination or estimate of a current and/or future position of a mobile POT device as confirmed by two or more transaction events 420 (the plurality, in this case, called the triggering event). Of course, while the execution of transmitting information associated with the merchant (i.e. distribution of an offer or advertisement) may take place immediately or nearly immediately from the time a geographically targeted audience is determined 130, there may be a greater length of time (e.g. minutes, hours, etc) before an appropriate determination of the approximate current or future location mobile POT device can be appropriately made based on, at least in part, financial transaction information 110.

In some embodiments, the apparatus having the process flow 100 is configured to automatically perform one or more portions of the process flow 100 represented by blocks 110-140, whereas in other embodiments, one or more of the portions of the process flow 100 represented by blocks 110-140 require and/or involve human intervention (e.g., a user operating the apparatus configured to perform the process flow 100, etc.).

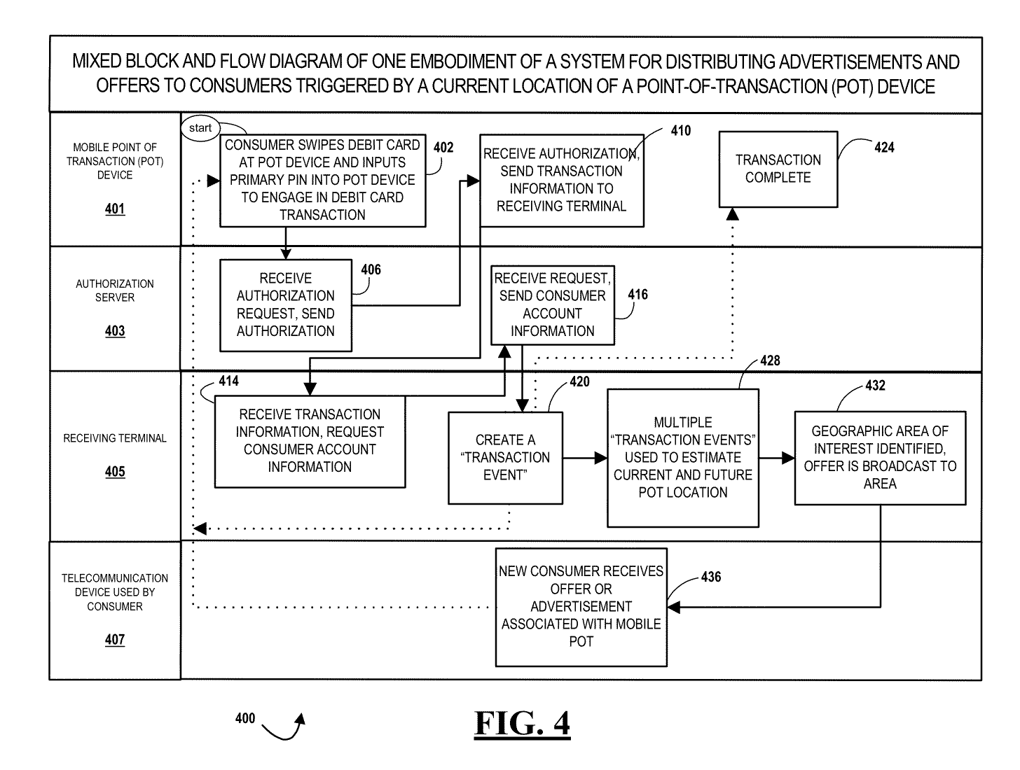

It will be understood that the apparatus having the process flow 100 can be configured to perform one or more portions of any embodiment described and/or contemplated herein, such as, for example, one or more portions of the process flow 200 described herein and/or one or more portions of the process flows described in connection with FIG. 3 or 4. Also, the number, order, and/or content of the portions of the process flow 100 are exemplary and may vary. For example, in some embodiments, the apparatus having the process flow 100 is configured to determine the approximate physical location of a mobile POT device by receiving information associated with a financial transaction on the mobile POT device, and by calculating the approximate physical location using, at least in part, the financial transaction data. In some embodiments the information associated with the financial transaction may include data retrieved from a GPS enabled device, either internal to the apparatus or external to, yet operatively connected with the apparatus, where the information associated with a financial transaction may include data retrieved from the GPS enabled device indicating GPS coordinates of the mobile POT.

In yet other embodiments, the POT device location may be approximated by a mobile phone antennae mast proximity method (also known as multilateration, triangulation, hyperbolic positioning, etc.). Multilateration can be used by a single receiver to locate itself by measuring the time difference of arrival of signals emitted from three or more synchronized cell phone transmitters at known locations. Those skilled in the art also know that simple navigation and locating systems can be constructed by analyzing the phase change difference of the signals emitted by two transmitters, rather than the time difference of arrival of a pulse, to define the hyperboloids used in estimating a physical location of a receiver. In such examples, phase-difference and time-difference can be considered the same for narrow-band transmitters. It will be understood that a multitude of location techniques exist and are commonly used in the telecommunications industry that do not employ global positioning system (GPS) technologies, or use hybrid systems which are known to operate using a combination of network-based and mobile receiver-based technologies determining the location or approximate location of a device.

As another example, in some embodiments, the apparatus is configured to approximate the mobile POT device location using a method that comprises (a) retrieving known information specific to a holder of an account by identifying the buyer account involved in a specific transaction on a mobile POT device, and (b) associating that consumer account information with the location of subsequent purchases made at brick-and-mortar business addresses using the same consumer account, within a specified time period, and (c) creating a “transaction event” which associates a specific buyer account with the aforementioned purchases, (d) identifying two or more buying events associated with the same mobile POT device, and (e) approximating the location of a mobile POT device using, at least in part, the known business addresses associated with the transaction events. It will be understood that the term “transaction event” used in the description of this and other embodiments may be called other terms (e.g. transaction event, objects, tokens, types, etc.). In this example, a “transaction event” would contain information such as the buyer account number (or for security purposes, a unique representation of the number), account home address, merchant addresses associated with subsequent purchases, times of purchases, etc. Again, it will be understood that the apparatus having the process flow 100 can be configured to perform one or more portions of any embodiment described and/or contemplated herein, such as, for example, one or more portions of the process flow 200 described herein and/or one or more portions of the other process flows.

As still another example, in some embodiments, the apparatus of process flow 100 is configured to receive the geographic location of a mobile POT device, which may be approximated using methods described herein or other methods, and calculate or otherwise determine an appropriate geographic location of the POT device used to determine a geographically targeted audience for use in transmitting information associated with the entity operating the POS device. In such embodiments, the geographic region may include information giving the projected location of the POT, which is based at least in part on known previous locations in a given timeframe (herein referred to as “historical location data”) associated with the device. In this example, historical location data might include the average time between financial transactions on the POT device, along with the approximated locations for the respective transactions. From such historical location data, a geographic region in which information is transmitted (e.g. the distribution of advertisements or offers) may be calculated by a method using, at least in part, travel rate or travel direction, as determined from the transaction data received from the mobile POT device. Alternately or alternatively, the geographic region may be calculated by a method using, at least in part, GPS location data retrieved from the positioning system of the mobile POT device, or using GPS location data retrieved from a GPS enabled device operatively connected to the mobile POT.

In reference to FIG. 1 block 140, consumers are located in or near the calculated geographic region of interest. The targeted audience will be understood to be consumers that reside or are otherwise located in the geographic region of interest. In some embodiments, information transmitted 140 is the distribution of advertisements or offers, where the advertisements or offers are delivered electronically to consumers (who are, as in some embodiments, members of the geographically targeted audience). As such, it will be assumed that the advertisements or offers are received and viewed on telecommunication devices capable of receiving advertisement messages, and the telecommunication devices are in possession or otherwise in view of the target audience. For example, a person living within the geographic region of interest with respect to the current location of an ice cream vendor is considered to be a member of the target audience. As the ice cream vendor approaches the location of the consumer, the consumer receives an SMS message on his phone indicating that the ice cream truck is approaching his home address. As another example, the same ice cream truck approaches a brick-and-mortar electronics store, in which several televisions are displaying a broadcast feed of a local cable television station. A brief pre-recorded commercial is shown on the television which indicates that the ice cream truck is approaching the business address. These examples are meant to be representations of various embodiments and are by no means intended to be limiting in the interpretation of the term “transmitting information,” which may have numerous other representations.

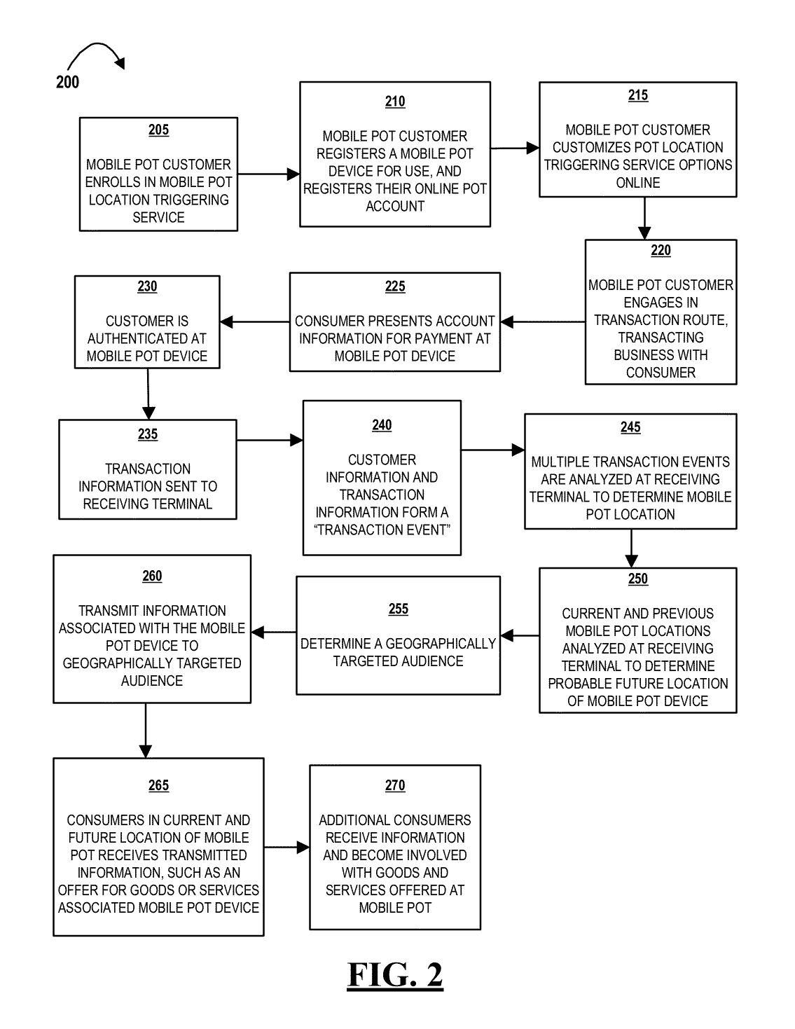

Referring now to FIG. 2, a more-detailed process flow 200 for triggering offers based on the detected location of a mobile point-of-transaction device is provided, in accordance with an embodiment of the present invention. It will be understood that the process flow 200 illustrated in FIG. 2 represents an example embodiment of the process flow 100 described in connection with FIG. 1. Thus, in some embodiments, the apparatus that is configured to perform the process flow 200 is also configured to perform the process flow 100 (and/or vice versa). Also, in some embodiments, the process flow 200 is performed at least partially by an apparatus having hardware and/or software configured to perform one or more portions of the process flow 200. Further, in some embodiments, the apparatus having the process flow 200 is maintained by a financial institution for the benefit of its customers. Also in accordance with some embodiments, the account holder referred to in the process flow 200 is the consumer purchasing goods and/or services using the mobile POT device, and is also a customer of the financial institution. In addition, the account referred to in the process flow 200 is an account held by the account holder (in this case, the consumer) and maintained by the financial institution. In other embodiments, the account holder may not be a customer of the financial institution, and therefore certain aspects of embodiments involving consumer account information specific to the account holder may not be available for the determination of the mobile POT device location. An example of unavailable account information is the home address of a consumer who is not a customer of the financial institution.

It will be understood that the consumer, who may or may not be a customer of the financial institution is distinct from the financial institution POT customer, who is generally a customer of the financial institution and is also referred to as the POT operator, merchant and/or entity. As represented by block 205, the financial institution POT customer enrolls in a mobile POT location triggering service that uses a payment network. As represented by block 210, the apparatus having the process flow 200 is configured to communicate, via the network, with the apparatus of process flow 100. It will be understood that the POT customer may prompted in any way. Also, the apparatus may prompt the mobile POT customer to register the device for use, and register an online POT account related to the POT apparatus. An online POT account, in some embodiments, is a computer program product designed to give access to mobile POT customer account information through an operative Internet connection, using an Internet browser, for registration and customization of the mobile POT account.

Block 215, in some embodiments, allows the mobile POT customer to input usable location information such as a planned corridor of travel with respect to the mobile POT, sales territory information, past or present sales territory coverage, etc. For example, in some embodiments, the apparatus is configured to prompt the POT customer with identification credentials provided by the online POT account. As another example, in some embodiments, the apparatus prompts the mobile POT customer to map waypoints along a corridor of travel to indicate the intended route of travel for some period of time. In yet other embodiments, the apparatus prompts the mobile POT customer to associate the types of goods and/or services sold with known locations along an intended corridor of travel. An example would be an association of the sale of multiple baskets and umbrellas with the location of an outdoor market, where the market may lie in the corridor of intended travel. However, in other embodiments, the user interface prompts the POT customer (who may also be the POT operator, merchant, entity, etc.) to configure the apparatus to receive location data that is sent by the POT operator manually, or to be sent automatically by a pre-programmed instruction set as a part of a computer program product.

After registering the apparatus and configuring the mobile POT customer location triggering service options, the mobile POT customer engages in sales activities, transacting goods and/or services with consumers as represented by block 220. The financial transaction flow is represented by blocks 220-230. As represented by block 225, the holder presents account information at the transaction machine. For example, holder may swipe a debit and/or credit card associated with the account through the POT device in order to communicate account information associated with the account to the POT device and/or to the apparatus having the process flow 200. As another example, in some embodiments where the mobile POT device is a personal computer, the holder may input account information into a web page associated with the transaction that is displayed at the personal computer. After the account information is presented, the POT (and/or the apparatus having the process flow 200) identifies and/or authenticates the holder, as represented by block 230. In some embodiments, the POT authenticates the holder based at least partially on the account information (e.g., userid/password, PIN, checkcard, account number, etc.) the holder presents to the mobile POT.

After being authenticated, the holder selects the transaction and/or agrees to the transaction amount, as represented by block 235. Then, as represented by block 240, the POT sends an authorization request to the apparatus having the process flow 200, where the authorization request identifies and/or describes the transaction, the holder, the account, the transaction amount, and/or the like. Upon receiving the authorization request, the apparatus must assemble the received information to form a data structure, in this case referred to as a “transaction event.” After the transaction is completed at the POT, the customer leaves the transaction machine, and the mobile POT transacts additional financial transactions with consumers in the same location or in some other location along the corridor of travel as represented by block 245. In some embodiments, multiple transaction events are created using transaction information received from the apparatus of process flow 200, and an approximate or exact location of the mobile POT device is determined using, at least in part, the transaction information received from the mobile POT. In accordance with this embodiment, the determination of the location of the mobile POT can be made using the POT device apparatus, the receiving terminal 320, the authorization server 365, or any combination of apparatuses thereof.

Once a location is determined for the mobile POT device, the current and previous locations are analyzed to determine or estimate a future location of the POT device using information such as the time between transactions and the relative location of each transaction. In accordance with some embodiments, the analysis is done at the receiving terminal to determine the current and future location of the mobile POT device, and an estimate of the time of arrival at various waypoints along the projected corridor of travel. Such a determination, as represented by block 250, is made using a variety of methods, which may depend on the types of transaction information available with respect to the POT device in a relatively short time frame. A time frame used for analysis may vary, the length of which depends on the nature of the financial transactions associated with the POT device. The time frame used for analysis could range from a span of minutes to a span of one hour or more. For example, in the case of a mobile POT device used in an ice cream truck, several transactions (and therefore several transaction events) could be recorded on the receiving terminal within a time frame of five minutes. In such a case, a time frame for analysis from one to ten minutes might be appropriate for determining the location of the mobile POT. In another example, a mobile POT used by a knife sharpener selling her services from door to door in a residential neighborhood may transact three to five transactions within a period of two hours. In the latter case, a period of thirty minutes to two hours may be an appropriate time frame for analysis in determining the location of a mobile POT. In either case, a time frame chosen to analyze transaction information for determining location in one case may not be appropriate for the location determination in the other.

After making a determination of the current and future location of the mobile POT device, an appropriate geographic region to transmit information is calculated as represented by block 255. The apparatus of process flow 200 is configured such that certain criteria are used to distinguish an appropriate region to which information will be transmitted. Some embodiments may use criteria such as the rate of travel along a corridor of travel, the predicted direction of travel along the corridor of travel, the length of time between transactions, or the nature of the goods and/or services associated with the transactions. The referenced criteria are representative of the types of information that may be used in determining an area, and is not to be interpreted as an exclusive or exhaustive list. Of course, each embodiment will use distinct criteria with which a determination will be made.

As an example of determining the location of a mobile POT device 245 using the nature of the goods sold, consider for example, items A, B, F, and G that are normally associated with a Farmer's Market at location X. On any given day, items A, B, F and G are purchased on the same account within a relatively short timeframe. In some embodiments, the computer program product may, using the transaction information from the purchase of items A, B, F and G, discover the relationships between specific goods and services involved in transactions and geographic locations in which they may be sold. The purchase of each of A, B, F and G need not be in the same transaction, but may be associated with one another as a group by the timeframe in which the transactions were made. When a different payment account is used to purchase items A, B and G at a relatively short time span from the previous transaction, an association is made that raises the probability that the mobile POT is at location X.

Block 260 represents the execution of an instruction by the computing system for transmitting information in block 255, directed to a geographically targeted area. For example, in one embodiment the execution of an instruction for transmitting information can range from sending appropriately chosen SMS text messages to SMS enabled devices located within the calculated geographic region of block 255. In yet another embodiment, the apparatus associated with block 255 is configured to send an automated email to marketing personnel indicating the appropriate flyer and area in which the flyer should be distributed. Block 260 represents any number of appropriate activities that could be planned, coordinated, executed or otherwise accomplished using the apparatus of process flow 200.

After an offer or advertisement is sent to a consumer who is part of the geographically targeted audience, the offer arrives on a telecommunications device in possession of or in view of a consumer. Block 265 represents the receipt of an offer that has been distributed to a consumer. The consumer reads the offer, for example, on a “smart” phone or other device, and after learning of the goods and/or service associated with the mobile POT the consumer takes action to become involved with the goods and/or services as shown in block 270.

In accordance with some embodiments, consumers in receipt of information associated with the mobile POT device are offered an invitation to respond to the information on their telecommunications device, smart phone, personal computer or other device being used to access the sent information. The invitation for a response may include, as an example, a “yes or no” response option to indicate immediate interest in the sent information. In such an embodiment, information is transmitted 260 to a geographically targeted audience in an area within range of the sales route of an ice cream truck. Consumers in receipt of the transmitted information 265 read the short message in reference to the ice cream vendor, and respond whether or not they have in interest in purchasing ice cream if the vendor were to conduct business in their neighborhood. The consumer responds “yes,” as do ten of the consumer's neighbors who are also in receipt of the transmitted information. The entity associated with the mobile POT device, in this case the ice cream vendor, can see a map of the area with “waypoint” dots on the map indicating the location of interested responders. Accordingly, the merchant modifies his sales corridor of travel to accommodate the interested consumers, and the consumers are able to purchase the goods offered by the merchant 270.

Embodiments also include a method, system and computer program product configured to schedule a “hand off” of a portion of a route to another operator based on a high level degree of response to a transmitted message 260. As an example, if many more consumers respond to a transmitted offer than one ice cream vendor can manage in her sales route, a “hand off” occurs, where a portion of the sales route is automatically given to another vendor using an operatively linked mobile POT device. In such a “hand off,” the second mobile POT operator receives instructions sent by the computing system of process flow 200 indicating the location assignment and waypoints of interested consumers. Accordingly, the second merchant is able to service interested consumers 270.

In yet another embodiment of the present invention, the information transmitted 260 may be associated with a service, such as a package delivery service. For example, a delivery person using a mobile POT device is in the area of a consumer, who is expecting the delivery of a package. The computing system sends a message to the consumer 260 and the consumer reads the text message that the delivery person will be in the area at a given range of time. An invitation for a consumer response is offered with the information 265. The consumer, however, is away from his home address, and will be at his home address at the end of the given delivery time range. The consumer responds to the message, giving the best time for delivery 265. The response is recorded by the apparatus associated with system process flow 200, along with the response of other consumers responding to the transmitted message 260 in the geographically targeted area. On a display configured to show consumer responses, the delivery person sees a map of the area showing addresses on the map to which there are deliveries scheduled, along with preferred delivery times logged by system 200 as responded by the consumers. At each waypoint, there is a time shown indicating the consumer's delivery time preference. Accordingly, the delivery person can modify her route to best accommodate the consumers in her area 270. Additionally, the system of process flow 200 may be configured to send a follow-up response to the consumer respondents, giving further confirmation of the schedule change and anticipated delivery time.

Of course, it will also be understood that the embodiment illustrated in FIG. 2 is merely exemplary and that other embodiments may vary without departing from the scope and spirit of the present invention.

Referring now to FIG. 3, a system 300 for triggering offers based on a detected location of a mobile point-of-transaction device is provided, in accordance with an embodiment of the present invention. As illustrated, the system 300 includes a network 310, a receiving terminal 320, a mobile POT 330, a mobile telecommunication device 340, a miscellaneous telecommunication device 350, and an authorization server 365. FIG. 3 also shows a consumer 302 and transaction information 308. The transaction information 308 includes consumer account information 308A, global positioning system (GPS) information and/or accelerometer data 308B, and item or service information 308C. As shown, the consumer 302 has access to the mobile telecommunication device 340, and has view of the miscellaneous telecommunication device 350.

In some embodiments, the receiving terminal 320, the mobile POT device 330, and the authorization server 365 are each maintained by the same financial institution. For example, in some embodiments, the consumer 302 is a customer of the financial institution, and the mobile telecommunication device 340 is embodied as an Internet enabled smart phone owned and maintained by the consumer 302. However, in other embodiments, the mobile POT 330 and the receiving terminal 320, and the mobile telecommunications device 340 are maintained by separate entities. For example, in some embodiments, the mobile POT device 330 is embodied as a tablet personal computer maintained by a merchant. In accordance with some embodiments, the mobile device 340 is associated with the consumer 302 and/or is carried, owned, possessed, and/or owned by the consumer 302. And the receiving terminal 320 is owned and maintained by the financial institution.

As shown in FIG. 3, the receiving terminal 320, the mobile POT 330, the authorization server 365, the receiving terminal 320, and the mobile phone 340 are each operatively and selectively connected to the network 310, which may include one or more separate networks. The network 310 may include one or more payment networks (e.g., interbank networks, Visa's® payment network VisaNet®, MasterCard's® payment network BankNet®, any wireline and/or wireless network over which payment information is sent, etc.), telephone networks (e.g., cellular networks, CDMA networks, any wireline and/or wireless network over which communications to telephones and/or mobile phones are sent, etc.), local area networks (LANs), wide area networks (WANs), global area networks (GANs) (e.g., the Internet, etc.), and/or one or more other telecommunications networks. For example, in some embodiments, the network 310 includes a telephone network (e.g., for communicating with the mobile device 340, and a payment network (e.g., for communicating with the mobile POT 320 and the authorization server 365, etc.). It will also be understood that the network 310 may be secure and/or unsecure and may also include wireless and/or wireline technology.

The receiving terminal 320 may include any apparatus described and/or contemplated herein. In addition, the receiving terminal 320 may be configured to perform any function and/or any portion of any process flow described and/or contemplated herein. For example, in some embodiments, the receiving terminal 320 is embodied as a server operated by the financial institution and configured to communicate with the mobile POT by receiving transaction and location information. In yet other embodiments, the receiving terminal 320 may be dedicated entirely to receiving transaction information from a network of mobile POT devices 330, and performing the functions of determining an entity associated associated with the POT device, and/or determining a current geographic location of the mobile POT device and/or determining a geographically targeted audience, and/or transmitting information associated with an entity 330. In accordance with other embodiments, the receiving terminal 320 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, etc.); withdrawing cash; making deposits (e.g., cash, checks, etc.); making payments (e.g., paying telephone bills, sending remittances, etc.); accessing the Internet; and/or the like.

In some embodiments, the mobile POT device 330 (and/or one or more other portions of the system 300) requires its users and/or consumers to authenticate themselves to the mobile POT 320 and therefore the authorization server 365 before the mobile POT 330 will initiate, perform, complete, and/or facilitate a transaction. For example, in some embodiments, the mobile POT 330 is configured to authenticate a user based at least partially on an ATM/debit/credit card, loyalty/rewards/club card, smart card, token (e.g., USB token, etc.), username/password, personal identification number (PIN), biometric information, and/or one or more other credentials that the user presents to the receiving terminal 320. Additionally or alternatively, in some embodiments, the receiving terminal 320, authorization server 365, or the mobile POT device 360 is configured to authenticate a user by using one-, two-, or multi-factor authentication. According to some embodiments, the receiving terminal 320, authorization server 365, or the mobile POT device 360 requires two-factor authentication, such that the consumer 302 must provide a valid debit card and enter the correct PIN associated with the debit card in order to authenticate the consumer 302 to the mobile POT 330.

As illustrated in the embodiment of FIG. 3, the receiving terminal 320 includes a communication interface 322, a processor 324, a memory 326 having a POT offer triggering application 327 stored therein, and a user interface 329. In accordance with such embodiments, the processor 324 is operatively and selectively connected to the communication interface 322, the user interface 329, and the memory 326.

Each communication interface described herein, including the communication interface 322, generally includes hardware, and, in some instances, software, that enables a portion of the system 300, such as the receiving terminal 320, to send, receive, and/or otherwise communicate information to and/or from the communication interface of one or more other portions of the system 300. For example, the communication interface 322 of the receiving terminal 320 may include a modem, network interface controller (NIC), NFC interface, network adapter, network interface card, and/or some other electronic communication device that operatively connects the receiving terminal 320 to another portion of the system 300, such as, for example, the mobile POT device 330 and the authorization server 365.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the POT location offer triggering application 327 of the memory 326 of the receiving terminal 320.

Each memory device described herein, including the memory 326 for storing the POT location offer triggering application 327 and other information, may include any computer-readable medium. For example, the memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

As shown in FIG. 3, the memory 326 includes the POT location offer triggering application 327. It will be understood that the POT location offer triggering application 327 can be operable (e.g., usable, executable, etc.) to initiate, perform, complete, and/or facilitate one or more portions of any embodiment described and/or contemplated herein, such as, for example, one or more portions of the process flows 100 and/or 200 described herein and/or one or more portions of the process flows described in connection with FIG. 4. For example, in some embodiments, the POT location offer triggering application 327 is operable to receive transaction information associated with a transaction, where the transaction involves the consumer 302, the mobile POT 330, and the consumer with an account (also called a holder of the account).

In some embodiments, the POT location offer triggering application 327 is operable to enroll the financial institution POT customer, as shown in FIG. 2 block 205 in the mobile POT location triggering service. As another example, in some embodiments, POT location offer triggering application 327 is operable to allow the POT operator or merchant to customize the POT location triggering service options, as shown in block 215. In some of these embodiments, the POT location offer triggering application 327 is further operable to one or more of the operations in process flow 100.

In some embodiments, the POT location offer triggering application 327 is operable to enable the consumer 302 and/or receiving terminal 320 to communicate with one or more other portions of the system 300, and/or vice versa. In some embodiments, the POT location offer triggering application 327 is additionally or alternatively operable to initiate, perform, complete, and/or otherwise facilitate one or more financial and/or non-financial transactions. In some embodiments, the POT location offer triggering application 327 includes one or more computer-executable program code portions for causing and/or instructing the processor 324 to perform one or more of the functions of the POT location offer triggering application 327 and/or receiving terminal 320 described and/or contemplated herein. In some embodiments, the POT location offer triggering application 327 includes and/or uses one or more network and/or system communication protocols.

As shown in FIG. 3, the receiving terminal 320 also includes the user interface 329. It will be understood that the user interface 329 and/or 332 (and any other user interface described and/or contemplated herein) can include and/or be embodied as one or more user interfaces. It will also be understood that, in some embodiments, the user interface 329 includes one or more user output devices for presenting information and/or one or more items to the mobile POT device user (e.g., the consumer 302, the merchant etc.), such as, for example, one or more displays, speakers, receipt printers, dispensers (e.g., cash dispensers, ticket dispensers, merchandise dispensers, etc.), and/or the like. In some embodiments, the user interface 329 and/or 332 additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, styluses, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the mobile POT device user (e.g., the consumer and account holder 302, merchant or POT operator, etc.). In some embodiments, the user interface 332 and/or the mobile POT device 330 includes one or more vaults, security sensors, locks, and/or anything else typically included in and/or near the transaction machine.

As shown in FIG. 3, the system 300 also includes a mobile POT device 330. The mobile POT 330 may include any apparatus described and/or contemplated herein that is used for processing transactions with consumers. In addition, the mobile POT 330 may be configured to perform any function and/or any portion of any process flow described and/or contemplated herein. In some embodiments, such as the one illustrated in FIG. 3, the mobile POT 330 includes a communication interface 332, a processor 334, and a memory 336, which includes an mobile POT location triggering application 337 and an account datastore 338 stored therein. As shown, the communication interface 332 is operatively and selectively connected to the processor 334, which is operatively and selectively connected to the memory 336.

The mobile POT location offer triggering application 337 can be operable (e.g., usable, executable, etc.) to initiate, perform, complete, and/or facilitate any one or more portions of the process flows 100 and/or 200 described herein and/or one or more portions of the process flows described in connection with FIG. 3 or 4. For example, in some embodiments, the mobile POT location triggering application 327 and/or 337 is operable to receive transaction information associated with a transaction, where the transaction involves the payment account holder (or consumer) 302, the receiving terminal 320, and the holder's account. As another example, in some embodiments, the mobile POT location triggering application 327 and/or 337 is operable to determine an approximate current or future location of the mobile POT device by using, at least in part, transaction information received by the mobile POT device. As still another example, in some embodiments, the mobile POT location triggering application 327 and/or 337 is operable to authorize the transaction after receiving authorization from the financial institution authorization server 365. In some embodiments, the mobile POT location triggering application 327 and/or 337 is operable to instruct the mobile POT 330 to complete the transaction (e.g., complete a purchase transaction, accept a check for payment, etc.).

Additionally or alternatively, the mobile POT location triggering application 327 and/or 337 may also be operable to prompt a merchant or mobile POT operator to perform any of the functions of blocks 210-215.

In some embodiments, the mobile POT location triggering application 327 and/or 337 is operable to enable the mobile POT device 330 to communicate with one or more other portions of the system 300, such as, for example, the account datastore 338, the mobile device 340, the receiving terminal 320, the authorization server 365, etc., and/or vice versa. In addition, in some embodiments, the mobile POT location triggering application 327 and/or 337 is operable to initiate, perform, complete, and/or otherwise facilitate one or more financial and/or non-financial transactions. In some embodiments, the mobile POT location triggering application 337 includes one or more computer-executable program code portions for causing and/or instructing the processor 334 to perform one or more of the functions of the mobile POT location triggering application 327 and/or 337 the mobile POT device 330 that are described and/or contemplated herein. In some embodiments, the mobile POT location triggering application 327 and/or 337 includes and/or uses one or more network and/or system communication protocols.

In addition to the mobile POT location triggering application 327 and/or 337, the memory 336 also includes the account datastore 338. It will be understood that the account datastore 338 can be configured to store any type and/or amount of information. As shown, the account datastore 338 stores the transaction information 308, which includes account information 308A and, if applicable to the embodiment, global positioning service location data and/or accelerometer data 308B. The account information 308A may include any information associated with the account held by the holder (also the consumer) 302, including, for example, transaction information associated with one or more transactions involving the account (e.g., date/time, description, transaction amount, merchant category codes, etc.), information associated with one or more account holders (or consumers 302), information associated with one or more account preferences, billing information, and/or the like. The item or service information 308C may include any information associated with the actual goods and/or services associated with any one or more transactions associated with the account, such as item code, item and/or service description, and any information that identifies a product or service uniquely.

In addition to the transaction information 308, the account datastore 338 can include information associated with one or more accounts, account profiles, POT devices, mobile POT device users, transactions, mobile devices, and/or the like. In some embodiments, the account datastore 338 additionally or alternatively stores information associated with one or more electronic banking services (e.g., online banking, mobile banking, text banking, etc.).

Also, the account datastore 338 may include any one or more storage devices, including, but not limited to, datastores, databases, and/or any of the other storage devices typically associated with a computer system. It will also be understood that these datastores may store information in any known way, such as, for example, by using one or more computer codes and/or languages, alphanumeric character strings, data sets, figures, tables, charts, links, documents, and/or the like. Further, in some embodiments, the account datastore 338 includes information associated with one or more applications, such as, for example, the mobile POT location triggering application 337. In some embodiments, the account datastore 338 provides a real-time or near real-time representation of the information stored therein, so that, for example, when the processor 334 accesses the account datastore 338, the information stored therein is current or nearly current. Although not shown, in some embodiments, the receiving terminal 320 and the authorization server 365 may each include a datastore that is configured to store information associated with those respective apparatuses. It will be understood that these datastores can store information in any known way, can include information associated with anything shown in FIG. 3, and/or can be configured similar to the account datastore 338.

The system 300 and/or one or more portions of the system 300 may include and/or implement any embodiment of the present invention described and/or contemplated herein. For example, in some embodiments, the system 300 (and/or one or more portions of the system 300) is configured to implement any one or more embodiments of the process flow 100 described and/or contemplated herein in connection with FIG. 1, any one or more embodiments of the process flow 200 described and/or contemplated herein in connection with FIG. 2, any one or more embodiments of the process flow described and/or contemplated herein in connection with FIG. 4.

Referring now to FIG. 4, a mixed block and flow diagram of a system 400 for distributing advertisements and offers to consumers triggered by the current and future location of a point-of-transaction (POT) device, in accordance with an exemplary embodiment of the present invention. It will be understood that the system 400 illustrated in FIG. 4 represents an example embodiment of the process flow 200 described in connection with FIG. 2 and/or an example embodiment of the system 300 described in connection with FIG. 3. As shown, the system 400 includes a mobile POT device 401 accessible to a consumer, an authorization server 403 (e.g., the authorization server 365), a receiving terminal 405 which in some embodiments may be a server or other computer configured to receive transaction information, and a telecommunication device used by the consumer 407 (e.g., a smart phone, personal computer, television, radio, etc.), or a miscellaneous telecommunication device in view of the consumer. The mobile POT device 401, the authorization server 403, the receiving terminal 405, and the telecommunication device 407 may each include a communication interface, a user interface, a processor, a memory, an application, and/or a datastore, and those devices may be operatively connected to each other.

In accordance with some embodiments, the mobile POT device 401 and the receiving terminal 405 are each operatively and selectively connected to the authorization server 403 via one or more networks (not shown). For example, in some embodiments, the mobile POT device 401 is operatively connected to the authorization server 403 via the Internet, and/or the telecommunication device used by the consumer (e.g. mobile phone) 405 is operatively connected to the Internet. Also, in this example embodiment, the consumer is a customer of a financial institution, and the mobile 401 is accessible to the consumer for the presentation of payment credentials (e.g. a bank card, credit card, etc) at the time that the transaction is made for the purchase of goods and or services at the mobile POT. Also, in this example embodiment, the mobile POT device 401 is maintained by the financial institution, the receiving terminal 405 is maintained by the financial institution, and the authorization server 403 is maintained by the financial institution. Further, in accordance with some embodiments, the financial institution maintains the account held by the holder (the consumer) in FIG. 4.

As represented by block 402, the consumer swipes her debit card at the POT device and inputs her primary PIN (personal identification number) into the POT device to engage in a transaction for purchasing goods and/or services from the merchant operating the mobile POT. The mobile POT device 401, via a payment network as shown in block 310, sends the authorization request to the authorization server 403. Next, as represented by block 406, the authorization server 403 receives the transaction request, and approves or declines the transaction (in the embodiment shown the transaction is approved). The transaction approval is sent to the mobile POT device 401, where the transaction is complete, as represented by block 424. The consumer, after completing the purchase, later completes a subsequent purchase at a nearby brick-and-mortar business. While the subsequent purchase made by the consumer is not shown in the diagram, it will be understood that the subsequent purchase information in reference to the purchase made by the consumer (who is also, in this example, a customer of the financial institution maintaining 401, 403 and 405), is available to the authorization server. In yet other embodiments, consumer account information is not available to the receiving terminal 405 because the consumer is not a customer of the financial institution described herein.

The mobile POT device 401 next sends the transaction information to the receiving terminal 405, and the receiving terminal 405 receives the data as shown in block 414. Included in the transaction information received at the receiving terminal 405 is the transaction information identifying the payment account (i.e. consumer account number, the transaction amount, etc.). A request is sent by the receiving terminal 405 to the authorization server 403 for consumer account information to be used in the determination of location of the mobile POT device. As represented in block 416, the authorization server 403 receives the request and sends the applicable consumer account information to the receiving terminal 405. As shown in block 420, a transaction event is created which, in some embodiments, is a set of data that is used by the apparatus of process flow 400 to determine the location of the mobile POT device 401.

It will be understood that the term “transaction event” represents a data structure in block 420, and is used in this embodiment to represent a grouping of consumer account information, account holder information, transaction information (e.g. date/time, description, transaction amount, merchant category codes, etc.), and the like. In some embodiments, a transaction event grouping of information is used, at least in part, to identify an approximate or exact location for a mobile POT device.

Next, the consumer completes one or more subsequent transactions at locations near the location of the mobile POT 401. As depicted in block 428, since the consumer example in this embodiment is a customer of the same financial institution as the financial institution maintaining the mobile POT 401 and/or the authorization server 403 and/or the receiving terminal 405, the subsequent transaction information is available to the authorization server, and therefore available to the receiving terminal. Block 428 represents the association of subsequent transactions involving the same consumer account holder and payment account for use by the receiving terminal 405 to determine the exact or approximate location of the mobile POT.

The receiving terminal 405 next uses, at least in part, the transaction information received from the mobile POT to estimate the current location of the mobile POT. For example, in one embodiment, the receiving terminal may determine that a transaction event associated with the mobile POT device 401 is created within eight minutes of a subsequent transaction event, which is not associated with the mobile POT, but associated with the same consumer payment account “A”, and at a stationary POT located at a known merchant location within 0.1 miles from the mobile POT 401. Six minutes later a transaction event is created involving a consumer payment account “B”, associated with the same mobile POT 401, and a third transaction event is recorded where the consumer payment account “B” makes a purchase four minutes later at a stationary POT located known merchant 0.05 miles from the physical location of the mobile POT 401. Using the available transaction event data, a single transaction event, or multiple transaction events, the receiving terminal 405 is configured to analyze all transaction event data, received within a relatively short period of time, to determine an approximate or exact location of the mobile POT. It will be understood that the time frames used for analysis, distance relationships, and the numbers of transaction events used to make a location determination, as described in embodiment representations, are representative only and of course will vary with each embodiment.

Block 428 represents the receiving terminal 405 using recorded mobile POT locations to determine current and future locations of the mobile POT device. The receiving terminal 405 may use location information, time information or other available information to determining the rate of travel along a corridor of travel, and create a prediction of the future location of the mobile POT 401.

The receiving terminal 405 is configured to calculate an appropriate geographic area of interest to broadcast offers to consumers. An appropriate area may be calculated in some embodiments using criteria such as: the particular goods and services offered by mobile POT triggering service customer (i.e. the merchant or POT operator), past rate of travel, past territory covered within a time frame, time between transactions on the mobile POT device, etc. and/or the like. As represented by block 432, a geographic area of interest is identified, and an offer or advertisement associated with the goods and/or services offered by the merchant using the mobile POT is broadcast to consumers located in the geographic area of interest. A new consumer located in the geographic area of interest receives the offer or advertisement as shown in block 436. In some embodiments, the offer describes the goods and or services being offered by the merchant using the mobile POT device 401, and the approximate location of the merchant using the device as estimated in block 428. The new consumer responds to the offer received, and restarts a cycle at block 402 by engaging in a transaction at the mobile POT device.

Of course, the embodiment illustrated in FIG. 4 is merely exemplary and other embodiments may vary without departing from the scope and spirit of the present invention. For example, in some alternative embodiments, one or more portions of the process flow being performed by the authorization server 403 are performed instead by the receiving terminal 405. As another example, in some alternative embodiments, the consumer located within the geographic area of interest is sent a different type of message (e.g., text message, email, mobile banking-specific message, etc.). As another example, in some alternative embodiments, the approximate location of the mobile POT device is discovered using a different method, such as by using the positioning system 360 (FIG. 3) associated with the mobile POT device.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

A computer program which implements all or parts of the invention through the use of systems like those illustrated in FIG. 1, 2, 3 or 4 can take the form of a computer program product, including executable code, residing on a computer usable or computer readable storage medium.

Such a computer program can be an entire application to perform all of the tasks necessary to carry out the invention, or it can be a macro or plug-in which works with an existing general purpose application such as a spreadsheet or database program. A tangible medium may be used, but note, however, that the “medium” may also be a stream of information being retrieved when a processing platform or execution system downloads the computer program instructions through the Internet or any other type of network.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A computer implemented method for identifying a target audience for receiving information comprising:
receiving transaction information associated with a financial transaction that occurred on a mobile point-of-transaction (“POT”) device;
determining, via a computing system, an entity associated with the mobile POT device;
determining a current geographic location of the mobile POT device; and
determining a geographically targeted audience based at least partly on the current geographic location of the mobile POT device for use in transmitting information associated with the entity.

2. The method of claim 1, wherein transmitting information associated with the entity comprises transmitting information associated with the entity at a time triggered by the computing system.

3. The method of claim 1, wherein determining the current geographic location of the mobile POT device comprises determining the current geographic location based, at least in part, on the financial transaction information received from the mobile POT device.

4. The method of claim 1, wherein determining the current geographic location of the mobile POT device comprises determining the current geographic location based, at least in part, on GPS data received from the mobile POT device.

5. The method of claim 1, wherein receiving transaction information associated with a financial transaction comprises receiving financial transaction information comprising at least an item or service sold, a consumer account, and a holder of the consumer account.

6. The method of claim 1 further comprising defining a target area based on the current location of the mobile POT device, and wherein said determining a geographically targeted audience comprises defining the geographically targeted audience based on the target area.

7. The method of claim 1 further comprising defining a target area based on a time of day, and wherein said determining a geographically targeted audience comprises defining the geographically targeted audience based on the target area.

8. The method of claim 1 further comprising defining a target area based on the current calendar date, and wherein said determining a geographically targeted audience comprises defining the geographically targeted audience based on the target area.

9. The method of claim 1 further comprising defining a target area based on a type of good or service associated with the financial transaction, and wherein said determining a geographically targeted audience comprises defining the geographically targeted audience based on the target area.

10. The method of claim 1 further comprising defining a target area based on an input from the entity associated with the mobile POT device, and wherein said determining a geographically targeted audience comprises defining the geographically targeted audience based on the target area.

11. The method of claim 1 further comprising:
determining a projected future geographic location based on the current geographic location of the mobile POT device; and
defining a target area based on the projected geographic location of the mobile POT device, and
wherein said determining a geographically targeted audience comprises defining the geographically targeted audience based on the target area.

12. The method of claim 1, wherein determining a current geographic location of the mobile POT device comprises:
receiving information associated with two or more financial transactions from the mobile POT device, where the information comprises geographic information; and
approximating the current geographic location of the mobile POT device based at least in part on the geographic information associated with the information.

13. The method of claim 1, wherein determining a current geographic location of the mobile POT device comprises:
receiving information associated with a financial transaction from the mobile POT device, where the information comprises consumer account information associated with a consumer participating in the financial transaction;
determining a geographic address associated with the consumer account information; and
approximating the current geographic location of the mobile POT device based at least in part on the geographic address associated with the consumer account information.

14. The method of claim 1, wherein determining a current geographic location of the mobile POT device comprises:
receiving information associated with two or more financial transactions received from the mobile POT device, where the information comprises consumer account information associated with a consumer participating in the respective financial transaction;
determining a geographic address associated with the consumer account information for each of the financial transactions; and
approximating the current geographic location of the mobile POT device based at least in part on the geographic addresses associated with the consumer account information for the two or more financial transactions.

15. The method of claim 1 further comprising:
determining a projected future geographic location based at least in part on the current geographic location of the mobile POT device by determining a geographic address associated with two or more financial transactions received from the mobile POT device, where the geographic addresses indicate a projected path of travel for the mobile POT device.

16. The method of claim 1 further comprising:
determining a projected future geographic location based at least in part on the current geographic location of the mobile POT device by determining a geographic address associated with a financial transaction received from the mobile POT device and comparing the geographic address with a pre-planned corridor of travel to thereby determine a future geographic location.

17. The method of claim 1, further comprising defining a target area for transmitting information associated with the entity to users in the target area, said defining a target area comprising:
receiving information associated with first and second financial transactions conducted on the mobile POT device, wherein the information contains at least a time of sale;
determining a current geographic location of the mobile POT device where each of the first and second financial transactions occurred;
calculating a rate of travel for the mobile POT device in a given timeframe using, at least in part, time of sale information and the current geographic locations of the mobile POT device associated with the first and second financial transactions; and
defining a target area based at least in part on the calculated rate of travel.

18. The method of claim 1, further comprising defining a target area for transmitting information associated with the entity to users in the target area, said defining a target area comprising:
receiving information associated with first and second financial transactions conducted on the mobile POT device;
determining a current geographic location of the mobile POT device where each of the first and second financial transactions occurred;
determining a direction of travel based on the current geographic location determined for the first and second financial transactions; and
defining a target area based at least in part on the direction of travel.

19. The method of claim 1, further comprising defining a target area for transmitting information associated with the entity to users in the target area, said defining a target area comprising:
receiving information associated with first and second financial transactions conducted on the mobile POT device;
determining a current geographic location of the mobile POT device where each of the first and second financial transactions occurred;
receiving information from one or more responses to a previous transmission of information associated with said entity; and
defining a target area based at least in part on said receiving information from one or more responses to a previous transmission of information associated with said entity.

20. A system for identifying a target audience for receiving information, said system comprising:
a computing system configured for:
receiving transaction information associated with a financial transaction that occurred on a mobile point-of-transaction (“POT”) device;
determining an entity associated with the mobile POT device;
determining a current geographic location of the mobile POT device; and
determining a geographically targeted audience based at least partly on the current geographic location of the mobile POT device for use in transmitting information associated with the entity.

21. The system of claim 20, wherein transmitting information associated with the entity comprises transmitting information associated with the entity at a time triggered by the computing system.

22. The system of claim 20, wherein said computing system determines the current geographic location of the mobile POT device based, at least in part, on the financial transaction information received from the mobile POT device.

23. The system of claim 20, wherein said computing system determines the current geographic location of the mobile POT device based, at least in part, on GPS data received from the mobile POT device.

24. The system of claim 20, wherein said computing system determines receives financial transaction information comprising at least an item or service sold, a consumer account, and a holder of the consumer account.

25. The system of claim 20, wherein said computing system is further configured for defining a target area based on the current location of the mobile POT device, and defining the geographically targeted audience based on the target area.

26. The system of claim 20, wherein said computing system is further configured for defining a target area based on a time of day, and defining the geographically targeted audience based on the target area.

27. The system of claim 20, wherein said computing system is further configured for defining a target area based on the current calendar date, and defining the geographically targeted audience based on the target area.

28. The system of claim 20, wherein said computing system is further configured for defining a target area based on a type of good or service associated with the financial transaction, and defining the geographically targeted audience based on the target area.

29. The system of claim 20, wherein said computing system is further configured for defining a target area based on an input from the entity associated with the mobile point-of-transaction device, and defining the geographically targeted audience based on the target area.

30. The system of claim 20, wherein said computing system is further configured for:
determining a projected future geographic location based on the current geographic location of the mobile POT device; and
defining a target area based on the projected geographic location of the mobile POT device, and
defining the geographically targeted audience based on the target area.

31. The system of claim 20, wherein said computing system determines a current geographic location of the mobile POT device by being configured for:
receiving information associated with two or more financial transactions from the mobile POT device, where the information comprises geographic information; and
approximating the current geographic location of the mobile POT device based at least in part on the geographic information associated with the information.

32. The system of claim 20, wherein said computing system determines a current geographic location of the mobile POT device by being configured for:
receiving information associated with a financial transaction from the mobile POT device, where the information comprises consumer account information associated with a consumer participating in the financial transaction;
determining a geographic address associated with the consumer account information; and
approximating the current geographic location of the mobile POT device based at least in part on the geographic address associated with the consumer account information.

33. The system of claim 20, wherein said computing system determines a current geographic location of the mobile POT device by being configured for:
receiving information associated with two or more financial transactions received from the mobile POT device, where the information comprises consumer account information associated with a consumer participating in the respective financial transaction;
determining a geographic address associated with the consumer account information for each of the financial transactions; and
approximating the current geographic location of the mobile POT device based at least in part on the geographic addresses associated with the consumer account information for the two or more financial transactions.

34. The system of claim 20, wherein said computing device is further configured for:
determining a projected future geographic location based at least in part on the current geographic location of the mobile POT device by determining a geographic address associated with two or more financial transactions received from the mobile POT device, where the geographic addresses indicate a projected path of travel for the mobile POT device.

35. The system of claim 20, wherein said computing device is further configured for:
determining a projected future geographic location based at least in part on the current geographic location of the mobile POT device by determining a geographic address associated with a financial transaction received from the mobile POT device and comparing the geographic address with a pre-planned corridor of travel to thereby determine a future geographic location.

36. The system of claim 20, wherein said computing system is further configured for defining a target area by being configured for:
receiving information associated with first and second financial transactions conducted on the mobile POT device, wherein the information contains at least a time of sale;
determining a current geographic location of the mobile POT device where each of the first and second financial transactions occurred;
calculating a rate of travel for the mobile POT device in a given timeframe using, at least in part, time of sale information and the current geographic locations of the mobile POT device associated with the first and second financial transactions; and
defining a target area based at least in part on the calculated rate of travel.

37. The system of claim 20, wherein said computing system is further configured for defining a target area by being configured for:
receiving information associated with first and second financial transactions conducted on the mobile POT device;
determining a current geographic location of the mobile POT device where each of the first and second financial transactions occurred;
determining a direction of travel based on the current geographic location determined for the first and second financial transactions; and
defining a target area based at least in part on the direction of travel.

38. The system of claim 20, wherein said computing system is further configured for defining a target area by being configured for:
receiving information associated with first and second financial transactions conducted on the mobile POT device;
determining a current geographic location of the mobile POT device where each of the first and second financial transactions occurred;
receiving information from one or more responses to a previous transmission of information associated with said entity; and
defining a target area based at least in part on said receiving information from one or more responses to a previous transmission of information associated with said entity.

39. A computer program product for identifying a target audience for receiving information, the computer program product comprising a computer-readable medium having computer readable program instructions stored therein, wherein said computer-readable program instructions comprise:
first instructions configured for receiving transaction information associated with a financial transaction that occurred on a mobile point-of-transaction (“POT”) device;
second instructions configured for determining an entity associated with the mobile POT device;
third instructions configured for determining a current geographic location of the mobile POT device; and
fourth instructions configured for determining a geographically targeted audience based at least partly on the current geographic location of the mobile POT device for use in transmitting information associated with the entity.

40. The computer program product of claim 39, further comprising fifth instructions configured for transmitting information associated with the entity at a time triggered by the fifth instructions.

41. The computer program product of claim 39, wherein said third instructions are configured for determining the current geographic location based, at least in part, on the financial transaction information received from the mobile POT device.

42. The computer program product of claim 39, wherein said third instructions are configured for determining the current geographic location based, at least in part, on GPS data received from the mobile POT device.

43. The computer program product of claim 39, wherein said first instructions are configured for receiving financial transaction information comprising at least an item or service sold, a consumer account, and a holder of the consumer account.

43. The computer program product of claim 39 further comprising fifth instructions configured for defining a target area based on the current location of the mobile POT device, and wherein said fourth instructions are configured for defining the geographically targeted audience based on the target area.

44. The computer program product of claim 39 further comprising fifth instructions configured for defining a target area based on a time of day, and wherein said fourth instructions are configured for defining the geographically targeted audience based on the target area.

45. The computer program product of claim 39 further comprising fifth instructions configured for defining a target area based on the current calendar date, and wherein said fourth instructions are configured for defining the geographically targeted audience based on the target area.

46. The computer program product of claim 39 further comprising fifth instructions configured for defining a target area based on a type of good or service associated with the financial transaction, and wherein said fourth instructions are configured for defining the geographically targeted audience based on the target area.

47. The computer program product of claim 39 further comprising fifth instructions configured for defining a target area based on an input from the entity associated with the mobile point-of-transaction device, and wherein said fourth instructions are configured for defining the geographically targeted audience based on the target area.

48. The computer program product of claim 39 further comprising:
fifth instructions configured for determining a projected future geographic location based on the current geographic location of the mobile POT device; and
sixth instructions configured for defining a target area based on the projected geographic location of the mobile POT device, and
wherein said fourth instructions are configured for defining the geographically targeted audience based on the target area.

49. The computer program product of claim 39, wherein said third instructions for determining a current geographic location of the mobile POT device comprises instructions configured for:
receiving information associated with two or more financial transactions from the mobile POT device, where the information comprises geographic information; and
approximating the current geographic location of the mobile POT device based at least in part on the geographic information associated with the information.

50. The computer program product of claim 39, wherein said third instructions for determining a current geographic location of the mobile POT device comprises instructions configured for:
receiving information associated with a financial transaction from the mobile POT device, where the information comprises consumer account information associated with a consumer participating in the financial transaction;
determining a geographic address associated with the consumer account information; and
approximating the current geographic location of the mobile POT device based at least in part on the geographic address associated with the consumer account information.

51. The computer program product of claim 39, wherein said third instructions for determining a current geographic location of the mobile POT device comprises instructions configured for:
receiving information associated with two or more financial transactions received from the mobile POT device, where the information comprises consumer account information associated with a consumer participating in the respective financial transaction;
determining a geographic address associated with the consumer account information for each of the financial transactions; and
approximating the current geographic location of the mobile POT device based at least in part on the geographic addresses associated with the consumer account information for the two or more financial transactions.

52. The computer program product of claim 39 further comprising:
fifth instructions configured for determining a projected future geographic location based at least in part on the current geographic location of the mobile POT device by determining a geographic address associated with two or more financial transactions received from the mobile POT device, where the geographic addresses indicate a projected path of travel for the mobile POT device.

53. The computer program product of claim 39 further comprising:
fifth instructions configured for determining a projected future geographic location based at least in part on the current geographic location of the mobile POT device by determining a geographic address associated with a financial transaction received from the mobile POT device and comparing the geographic address with a pre-planned corridor of travel to thereby determine a future geographic location.

54. The computer program product of claim 39 further comprising fifth instructions configured for defining a target area for transmitting information associated with the entity to users in the target area, wherein said fifth instructions comprises instructions configured for:
receiving information associated with first and second financial transactions conducted on the mobile POT device, wherein the information contains at least a time of sale;
determining a current geographic location of the mobile POT device where each of the first and second financial transactions occurred;
calculating a rate of travel for the mobile POT device in a given timeframe using, at least in part, time of sale information and the current geographic locations of the mobile POT device associated with the first and second financial transactions; and
defining a target area based at least in part on the calculated rate of travel.

55. The computer program product of claim 39 further comprising fifth instructions configured for defining a target area for transmitting information associated with the entity to users in the target area, wherein said fifth instructions comprises instructions configured for:
receiving information associated with first and second financial transactions conducted on the mobile POT device;
determining a current geographic location of the mobile POT device where each of the first and second financial transactions occurred;
determining a direction of travel based on the current geographic location determined for the first and second financial transactions; and
defining a target area based at least in part on the direction of travel.

56. The computer program product of claim 39 further comprising fifth instructions configured for defining a target area for transmitting information associated with the entity to users in the target area, wherein said fifth instructions comprises instructions configured for:
receiving information associated with first and second financial transactions conducted on the mobile POT device;
determining a current geographic location of the mobile POT device where each of the first and second financial transactions occurred;
receiving information from one or more responses to a previous transmission of information associated with said entity; and
defining a target area based at least in part on said receiving information from one or more responses to a previous transmission of information associated with said entity.
